(19) United States
(12) Patent Application Publication
(10) Pub. No.: US 2005/0206802 A1
(43) Pub. Date: Sep. 22, 2005

(54) Display device comprising a light guide

(76) Inventor: Tijsbert Mathieu Henricus Creemers, Nijmegen (NL)

Correspondence Address: PHILIPS INTELLECTUAL PROPERTY & STANDARDS, P.O. BOX 3001, BRIARCLIFF MANOR, NY, 10510, US

(21) Appl. No.: 10/506,378

(22) PCT Filed: Feb. 7, 2003
(86) PCT No.: PCT/IB03/00470

§ 371 Date: Sep. 2, 2004

(30) Foreign Application Priority Data
Mar. 8, 2002 (EP) 02075932.0

(51) Int. Cl. G02F 1/1335

(52) U.S. Cl. 349/61

(57) ABSTRACT

A display device comprises row (5) and column (6) electrodes provided on a front plate and a light guide, a moveable element (3) provided with a common electrode (7), and means (17) for supplying voltages to the electrodes. A controllable image element is thereby formed on a crossing of the row and column electrodes. In dependence on driving pulses received by the electrodes, the moveable element can be set either to the front plate or the back plate. At one side of the light guide, light generated by a light source is coupled into the light guide. When the moveable element is in contact with the light guide, light is coupled out of the light guide at that location. Collimating means situated between the light source and the light guide improve the uniformity of the display device.

A display device of the type mentioned in the opening paragraph is known from the published international patent application WO 00/38163.

The known display device comprises a light source, a light guide, a second plate which is situated at some distance from the first plate and, between said two plates, a moveable element in the form of a membrane. By applying voltages to addressable electrodes on the first and second plates and an electrode on the membrane, the membrane can be locally brought into contact with the first plate, or the contact can be interrupted. In operation, light generated by the light source is coupled into the light guide by means of light coupling means. At locations where the membrane is in contact with the first plate, light is decoupled from said first plate. This enables an image to be represented. Furthermore, indium tin oxide (ITO) conductors are provided on the light guide for controlling the membrane. Furthermore, spacers are provided on the light guide for preventing the membrane from making contact with the light guide in a black state or uncontrolled state of the display device. Insulating layers are provided on both structures. A disadvantage of the known display device is that these structures introduce a decreased contrast of an image generated by the display device.

It is an object of the invention to provide a display device of the type mentioned in the opening paragraph having an improved contrast and uniformity.

To achieve this object, the display device according to the invention is specified in claim 1.

In this arrangement, the application of the collimating means reduces the number of reflections at the surfaces inside the light guide. The illumination of the display device closer to the light source will be less, but will still be sufficient. When the display device is driven in a white state, the moveable element couples less light out of the light guide per unit length, resulting in an improved uniformity of the display device. Furthermore, a loss per length unit, introduced by the structures i.e. the ITO conductors and the spacers is reduced. The reduction of light losses results in an increased light flux in the light guide.

A uniform illumination of the display is important, especially in large displays for use in computer monitors or televisions.

Further advantageous embodiments of the invention are specified in the dependent claims.

A special embodiment of the display device according to the invention is defined in claim 2. The wedge-shaped bar couples more collimated light into the light guide. This means that the light is travelling in an in-plane direction of the light guide, so that fewer reflections occur in the light guide.

Another embodiment of the device according to the invention is defined in claim 3. Such a structure is known per se from U.S. Pat No. 5,917,664. However, these plates are used to increase the on-axis brightness of Lambertian backlights commonly used in combination with liquid crystal displays (LCD), where these plates are positioned in front of the LCD directed to the viewer. In this application, the total light coupled out of the backlight to the LCD display is not increased, whereas in the display device according to the invention the total light flux out of the display device is increased by directing more light in an in-plane direction of the light guide.

A surface of the optically transparent plate can be provided with identical prisms or with pairs of prisms, wherein a pair comprises two prisms having different apex angles.

These and other aspects of the invention are apparent from and will be elucidated with reference to the embodiments described hereinafter.

In the drawings:

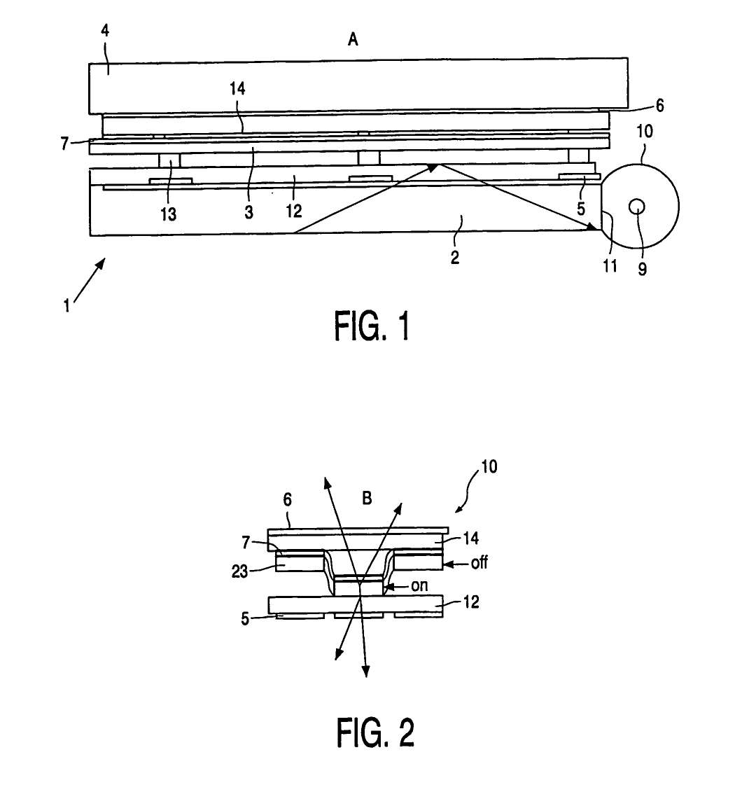

FIG. 1 is a cross-sectional view of a display device with a moveable element,

FIG. 2 shows a detail of the display device shown in FIG. 1,

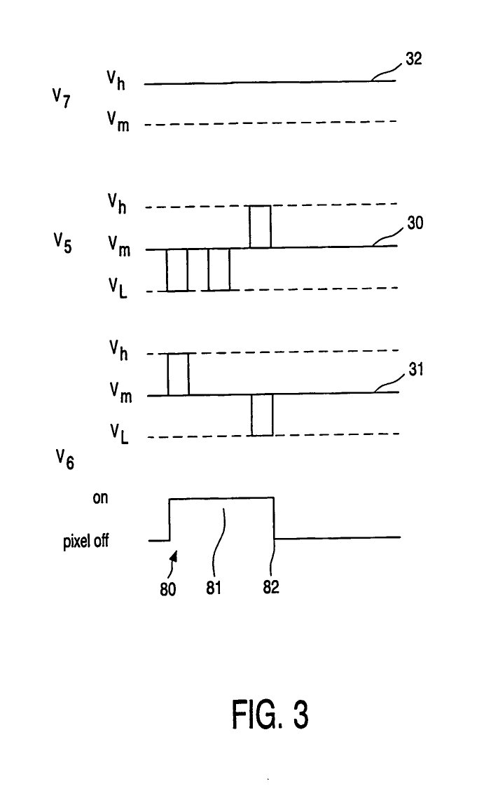

FIG. 3 shows an addressing scheme for the display device shown in FIG. 1,

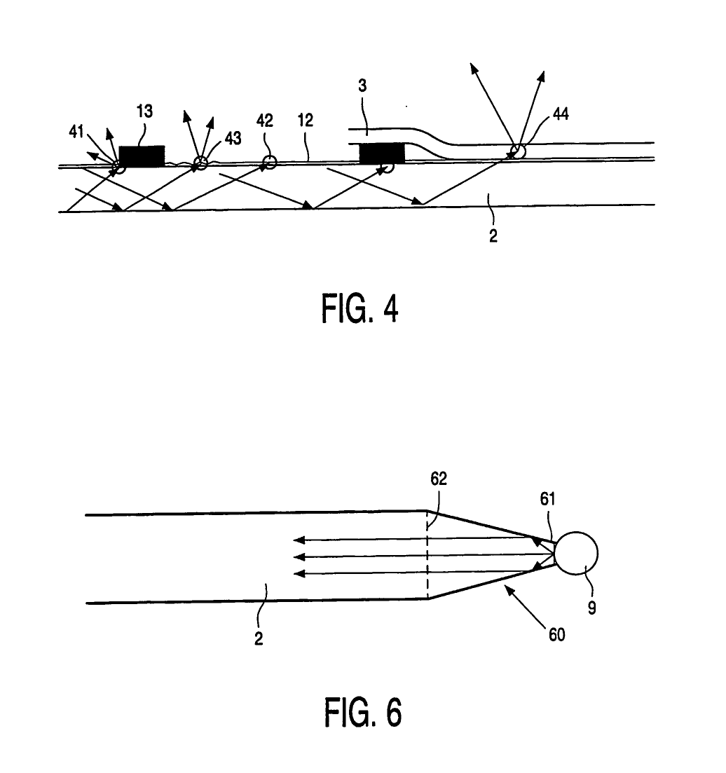

FIG. 4 shows possible light losses in the display device,

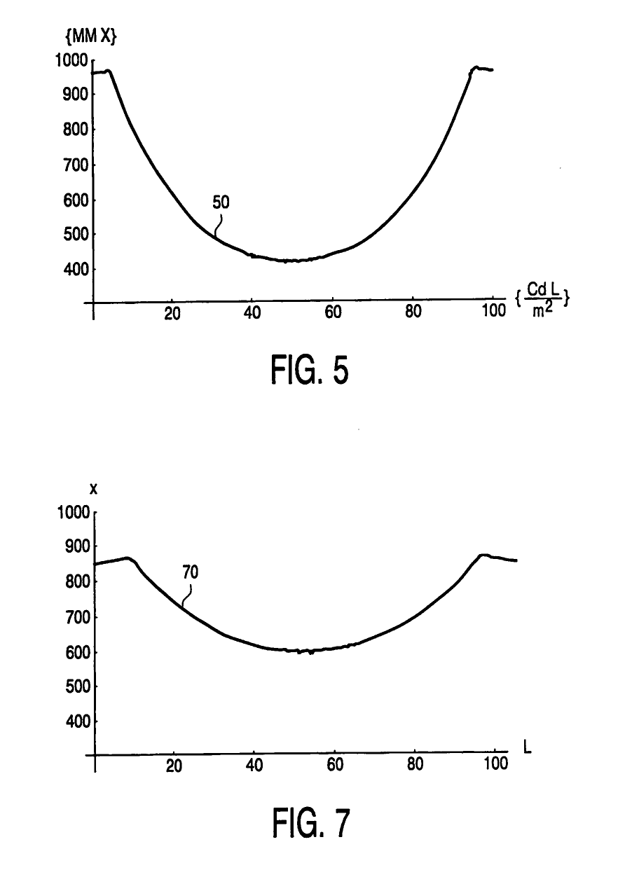

FIG. 5 shows a graph of the luminance of a known display device with a moveable element,

FIG. 6 shows a first example of a display device having a collimator between the light source and the light guide,

FIG. 7 shows a graph of the luminance of a display device having a collimator between the light source and the light guide,

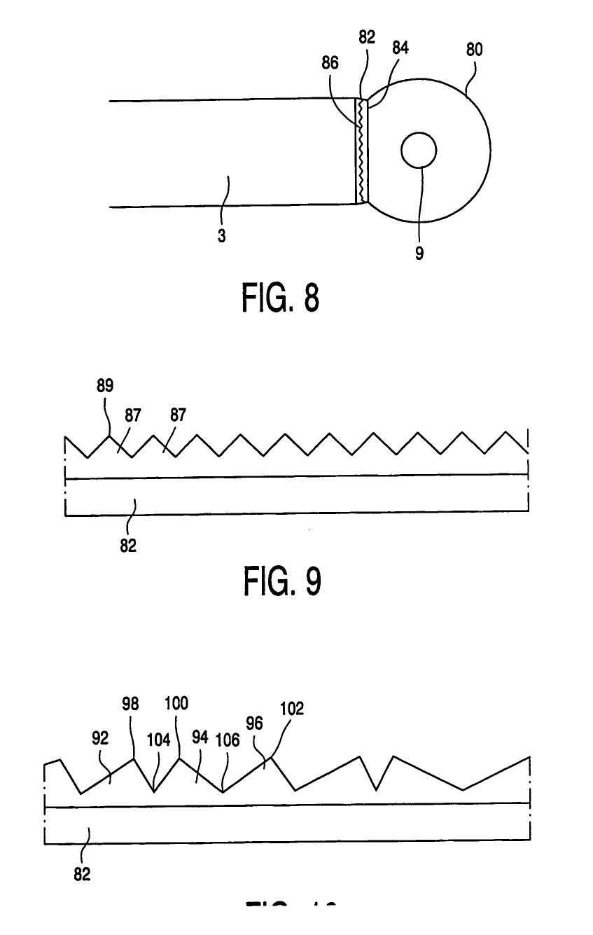

FIG. 8 shows a second example of a display device having a collimator between the light source and the light guide,

FIG. 9 shows a detail of a first example of an optically transparent plate for enhancing the on-axis brightness, and

FIG. 10 shows a detail of a second example of an optically transparent plate for enhancing the on-axis brightness.

The Figures are schematic and not drawn to scale, and, in general, like reference numerals refer to like parts.

FIG. 1 schematically shows a display device 1 comprising a light guide 2, a moveable element 3 and a second plate 4. In this example, the moveable element comprises a membrane. The membrane 3 may be made of a transparent polymer having a glass transition temperature of at least the operating temperature of the display device in order to prevent non-elastic deformation of the membrane. In practice, the operating temperature of the display device is in the range between about 0 and 70° C. A suitable transparent polymer is, for example, parylene which has a glass transition temperature of 90° C.

Electrode systems 5 and 6 are arranged, respectively, on the surface of the light guide 2 facing the membrane 3 and on the surface of the second plate 4 facing the membrane. Preferably, a common electrode is arranged on a surface of the membrane 3. The common electrode can be formed by, for example, a layer of indium tin oxide (ITO). In this example, the light guide is formed by a light-guiding plate 2. The light guide may be made of glass. The electrodes 5 and 6 form two sets of electrodes which cross each other at an angle of preferably 90°. By locally generating a potential difference between the electrodes 5, 6 and the membrane 3, by applying, in operation, voltages to the electrodes and electrode 7 on the membrane 3, forces are locally exerted on the membrane, which pull the membrane 3 against the light guide 2 or against the second plate 4.

The display device I further comprises a light source 9 and a reflector 10. Light guide 2 has a light input 11 in which light generated by the light source 9 is coupled into the light guide 2. The light source may emit white light, or light of any color, depending on the device. It is also possible that more than two light sources are present, for instance, a light source on two sides or on each side of the device. It is also possible to use light sources of different colors sequentially to form a white light display.

The membrane 3 is positioned between the light guide 2 and the second plate 4 by means of sets of spacers 13. Preferably, the electrode systems 5, 6 are covered by respective insulating layers 12 and 14 in order to preclude direct electric contact between the membrane 3 and the electrodes. By applying voltages to the electrodes 5,6,7, an electric force F is generated which pulls the membrane 3 against the electrode 5 on the light guide 2. The electrode 5 is transparent. The contact between the membrane 3 and the light guide 2 causes light to leave the light guide 2 and enter the membrane 3 at the location of the contact. The membrane scatters the light and a part of it leaves the display device 1 via the transparent electrode 5 and the light guide 2 and a part leaves through the second plate 4. It is also possible to use one set of transparent electrodes, the other being reflective, which increases the light output in one direction. The common electrode 7 comprises a conducting layer. Such a conducting layer may be a semi-transparent metal layer, such as a semi-transparent aluminium layer, a layer of a transparent conducting coating such as indium tin oxide (ITO) or a mesh of metal tracks.

In operation, the light travels inside the light guide and, due to internal reflection, cannot escape from it, unless the situation as shown in FIG. 2 occurs. FIG. 2 shows the membrane 3 lying against the light guide 2. In this state, a part of the light enters the membrane 3. This membrane 3 scatters the light, so that it leaves the display device 1. The light can exit at both sides or at one side. In FIG. 2, this is indicated by means of arrows. In embodiments, the display device comprises color-determining elements 20. These elements may be, for example, color filter elements allowing light of a specific color (red, green, blue, etc.) to pass. The color filter elements have a transparency of at least 20% for the spectral bandwidth of a desired color of the incoming light and a transparency in the range between 0 and 2% for other colors of the incoming light. Preferably, the color filter elements are positioned at the surface of the second plate 4 facing the light guide 2.

FIG. 3 shows an example of an addressing scheme for the display device 1.

A so-called multiple line addressing technique can be applied. A detailed description of this addressing technique can be found in the international patent application WO 00/38163, which is an earlier patent application in the name of the same applicant. This addressing method is very interesting, because it allows the membranes to be switched on or off with a single force acting on the structure. FIG. 3 shows three addressing states
a first addressing state “On” 80,
a second addressing state “Nothing happens due to bistability”
and a third addressing state “Off” 82.

A first graph 30 indicates the voltage on the column electrode 5, a second graph 31 indicates the voltage on the row electrode 6 and a third graph 32 indicates the voltage on the common electrode 7. It can be seen that, during switching, only a single force acts on the membrane 3. A fourth graph 33 indicates the on/off state of the corresponding display element.

FIG. 4 shows a detail of a known display device wherein the light losses in the light guide 2 and the membrane 3 are shown. Possible light losses are
41: absorption on and scattering at a bridge 13,
42: absorption in the ITO layer 5 provided at the light guide 2,
43: coupling out of the light guide by the roughness of the insulating layer 12,
44: scattering in the membrane 3.

FIG. 5 shows a first graph of a calculated luminance of a simulation of a known display device with a cosine or Lambertian light distribution for coupling light into the light guide. The calculation has been made for a 10-cm wide display driven in a full white state. This distribution shows a relatively high luminance at the borders of the display device and a relatively low luminance at the center of the display device. In order to reduce the possible light losses and to improve the brightness uniformity of the display device, a collimator is provided at the entrance face of the light guide.

In a first embodiment, this collimator comprises a wedge-shaped bar. FIG. 6 shows a detail of the display device having a collimator 60 between the light source 9 and the light guide 2. The wedge-shaped bar 60 is provided with a first surface 61 directed to the light source 9 and a second surface 62 optically coupled with the light guide 21 and being parallel to the first surface, the area of the first surface 61 being smaller than the area of the second surface 62. The application of a collimator reduces the number of reflections of the light at the boundaries of the light guide 2. Furthermore, the luminance of the display in the vicinity of the light source decreases, but not to such an extent that the luminance becomes insufficiently low, for example, below 100 Cd/m2. If the display device with the collimator is driven in a white state, the membrane couples less light out of the light guide, which improves the uniformity of the display device. Furthermore, the flux in the light guide is increased because the losses per unit length due to ITO, insulator and bridges are reduced.

FIG. 7 shows a second graph of a calculated luminance of a simulated display device with a collimator with a cos (2α) light distribution of the coupling of light into the light guide. The calculation has been made for a 10-cm wide display driven in a full white state. In the calculations of both graphs 50,70, the total light flux are kept equal in both cases. When the second graph 70 is now compared with the first graph 50 of the known display device of FIG. 4, the collimator in combination with the light guide provides a higher luminance in the area in the center of the display and an improved uniformity.

In a second embodiment of the display device, the collimator comprises an optically transparent plate, a surface of which is provided with a micro-optical surface. This kind of plate enhances the on-axis brightness i.e. the brightness in a direction perpendicular to the plane of the plate. An example of this kind of optically transparent plate is a brightness enhancement foil.

FIG. 8 shows a portion of a display device comprising a brightness enhancement foil 82 situated between the light source 9 and the light guide 3. The structured surface 84 of the brightness enhancement foil 82 faces the light source 9.

FIG. 9 shows a detail of a first example of an optically transparent plate 82, a surface of which is provided with multiple identical prisms 87 having equal prism angles 89.

FIG. 10 shows a detail of a second example of an optically transparent plate 82, a surface of which is provided with multiple linear prisms 92,94,96 disposed in pairs, each pair having first and second prisms and each prism having a prism angle 98,100,102 and a prism valley 104,106, wherein either the prism angles 98,100 or the valley angles, but not both, are equal.

It will be obvious that many variations are possible within the scope of the invention without departing from the scope of the appended claims.

1. A display device comprising a light source for generating light,
a light guide for transporting the generated light,
a plate which extends parallel in a mutually spaced relationship with the light guide;
a moveable element between the light guide and the plate;
selection means for locally bringing said moveable element into contact with the light guide for coupling light out of the light guide;
characterized in that the display device comprises collimating means for collimating the generated light between the light source and the light guide.

2. A device as claimed in claim 1, characterized in that the collimating means comprises a wedge-shaped bar provided with a first surface directed to the light source and a second surface optically coupled with the light guide and being parallel to the first surface, the area of the first surface being smaller than the area of the second surface.

3. A device as claimed in claim 1, characterized in that the collimating means comprises an optically transparent plate, wherein a surface of the optically transparent plate is provided with a structure for enhancing the on-axis brightness.

4. A device as claimed in claim 3, characterized in that the surface is provided with multiple linear prisms.

5. A device as claimed in claim 4, characterized in that the linear prisms are identical to each other.

6. A device as claimed in claim 4, characterized in that the prisms are disposed in pairs, each pair having first and second prisms and each prism having a prism angle and a prism valley, wherein either the prism angles or the valley angles, but not both, are equal.

7. A device as claimed in claim 6, characterized in that the prisms are directed to the light guide.

8. A device as claimed in claim 1, characterized in that the selection means comprises row and column electrodes.

9. A device as claimed in claim 1, characterized in that the device comprises means for applying voltages to the row and column electrodes in dependence on a previously applied voltage or voltages on the row and column electrodes.
